(19) United States
(12) Patent Application Publication
(10) Pub. No.: US 2008/0155653 A1
(43) Pub. Date: Jun. 26, 2008

(54) Manageable feed for distributing audio and/or video content for a specific user

(76) Inventor: Angelo Anthony Mandato, Dublin, OH (US)

Correspondence Address: ANGELO MANDATO, 2985 Curtis Knoll Dr., Dublin, OH, 43017, US

(21) Appl. No.: 11/615,988

(22) Filed: Dec. 24, 2006

(51) Int. Cl. H04L 9/32

(52) U.S. Cl. 726/2

(57) ABSTRACT

The techniques for producing a manageable collection of published audio and/or video data on Internet web servers for distribution for a specific user are provided. A user can implement managed collections of published audio and/or video on an Internet web server by interactively adding and removing specific content sources from a management console. The resulting subscription is accessible via a unique Really Simple Syndication (RSS) feed. The managed subscription is updated and returned when the uniquely identified RSS feed is accessed.

### BACKGROUND OF THE INVENTION

The present invention provides techniques for producing a manageable collection of published audio and/or video data on Internet web servers for listening and/or viewing by a specific user.

The Internet offers various ways for users to listen to and/or view published audio and/or video data. For example, Really Simple Syndication (RSS) provides a format for syndicating news and content of news-like sites. Users are required to use RSS-aware programs (aggregators) by maintaining information that refers to specific RSS locations (RSS location is a specific URL to an RSS feed on a web server). Each web site that provides RSS may have one or more RSS locations to refer to different published audio and/or video data based on the criteria of the web site publisher.

Often RSS users desire to combine sources of published audio and/or video data on Internet web servers. For example, an RSS user may want to have one specific RSS location to refer to multiple content sources. Current RSS sites do not provide a method for a user to manage a collection of specific audio and/or video data.

Currently, a RSS user must enter a separate site location to subscribe to specific audio and/or video data based on its content source. This may require the user to enter an infinite number of RSS locations into their RSS aggregator. Only when the actual audio and/or video data is downloaded to their personal computer may the user organize the content how he/she wishes.

A similar method for manageable RSS locations exists. U.S. Pat. No. 50,267,973 to PATENT OWNER demonstrates a method for managing categories of content as a single RSS feed for a specific user. The method assumes that the selection of managed content is based upon categories for which that content applies. This does not take into consideration the recent changes in the usage of feeds to distribute audio and/or video data. For example, a prestigious inventor creates her own audio program (recordings) regarding the subject of patents for distribution on a web site. On this same web site, another inventor creates his own audio program regarding the subject of patents. If the category to manage one's feed is based on patents, the user will inadvertently subscribe to both inventors (two content sources). In addition, the method in question implies that when additional sources of content are added that are in the same category they may be added to the user's managed feed. This does not allow a user to manage specific content sources for their personal RSS location.

Therefore, it would be desirable to provide techniques for producing a manageable collection of published audio and/or video data based on specific content sources via a single RSS location.

### SUMMARY OF THE INVENTION

The present invention provides techniques for producing a manageable collection of published audio and/or video data on Internet web servers via a unique feed location. Specifically, a user can enter their managed feed location into their RSS Aggregator. The user can manage the audio and/or video data based on the data's content sources. At any given time, the user can add or remove content sources to their managed feed location.

To give concrete form to this abstract invention, the managed feed location on a specified Internet web server sends the user syndicated audio and/or video data specified by the user in a management console. The management console allows the user to add and remove specific content sources. A content source may be an individual, a group of individuals, or an organization.

In another embodiment of the present invention, the managed feed location is unique and exclusively for the specified user. The managed feed location may be in the form of a unique domain name, a HTTP cookie, or a unique URL.

### BRIEF DESCRIPTION OF THE DRAWINGS

FIG. 1 is a diagram of the overall method for producing a Manageable feed for distributing audio and/or video content for a specific user.

FIG. 2 is a diagram of the method for a management console to be managed by a specific user.

FIG. 3 is a diagram of the method for generating the custom feed for a specific user.

FIG. 4 is a screenshot of a typical method that may be used to identify a user.

FIG. 5 is a screenshot of an example of a management console for adding and removing content sources to a user's custom feed.

FIG. 6 is a screenshot of a demonstration of multiple content sources found in a user's custom RSS feed.

FIG. 7 is a screenshot of a cross section of the generated managed feed.

### DETAILED DESCRIPTION OF THE PREFERRED EMBODIMENTS

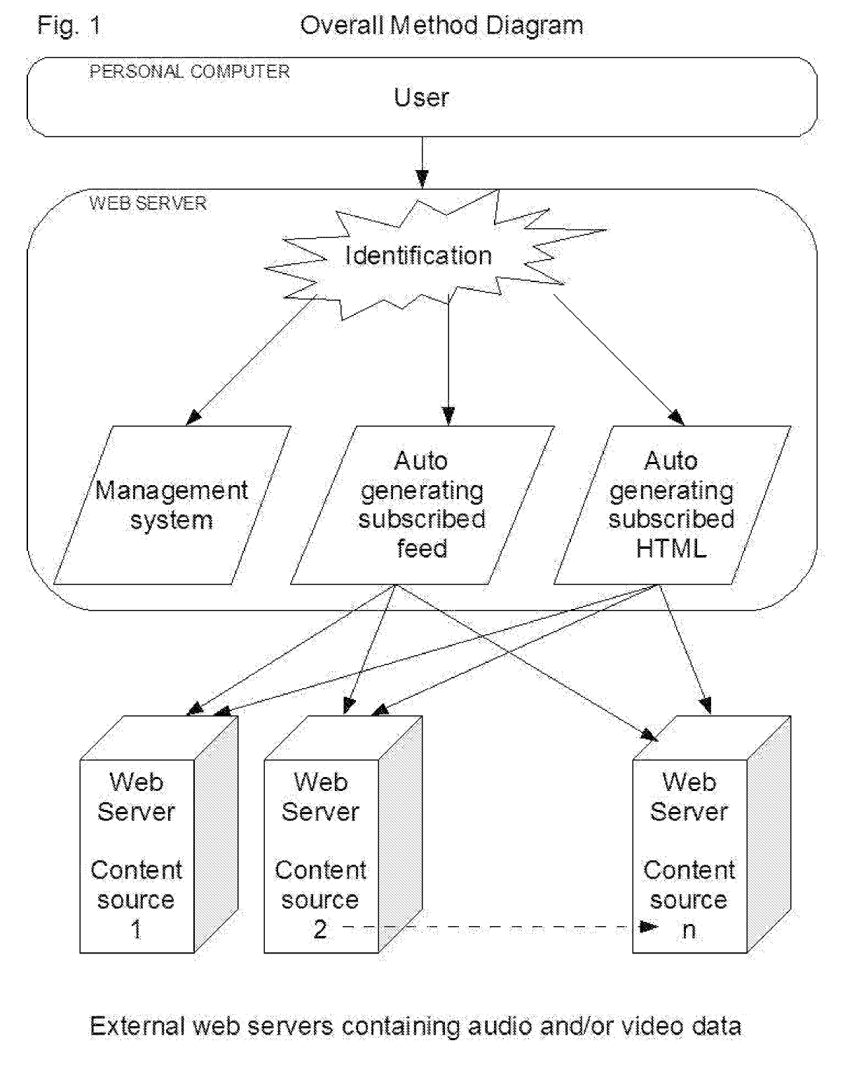

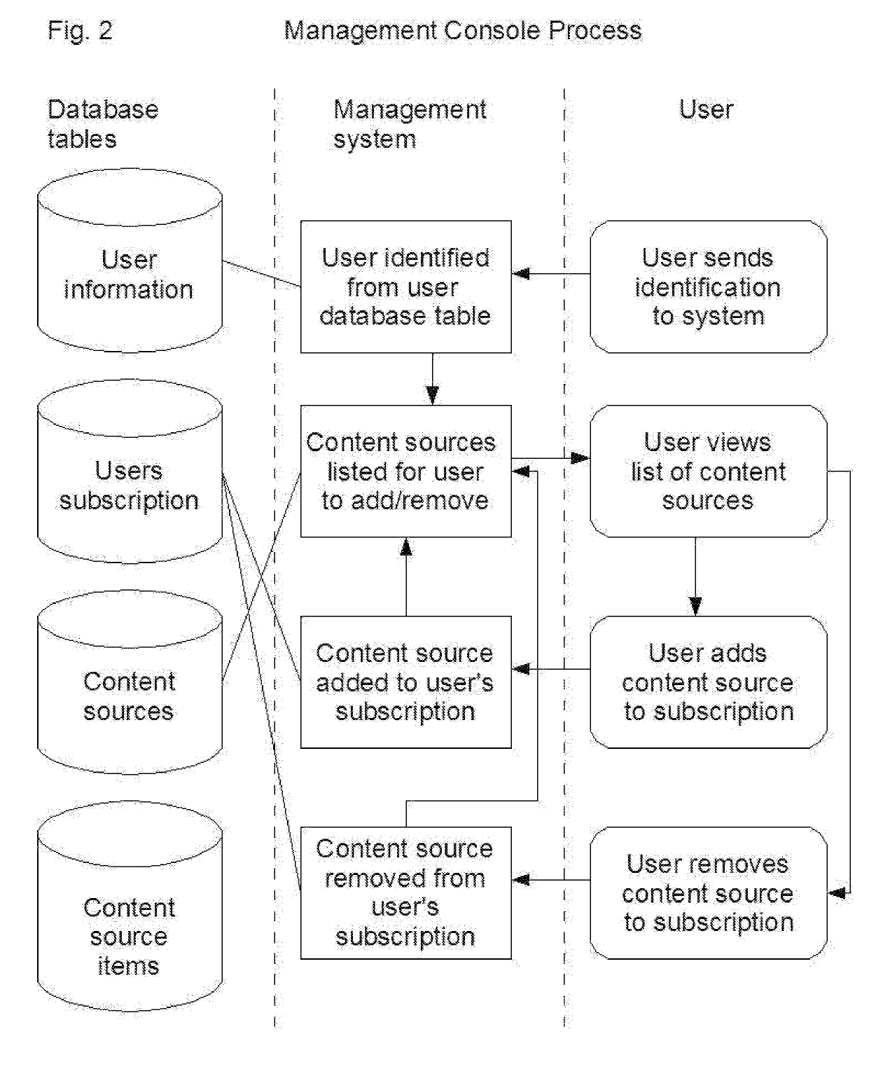

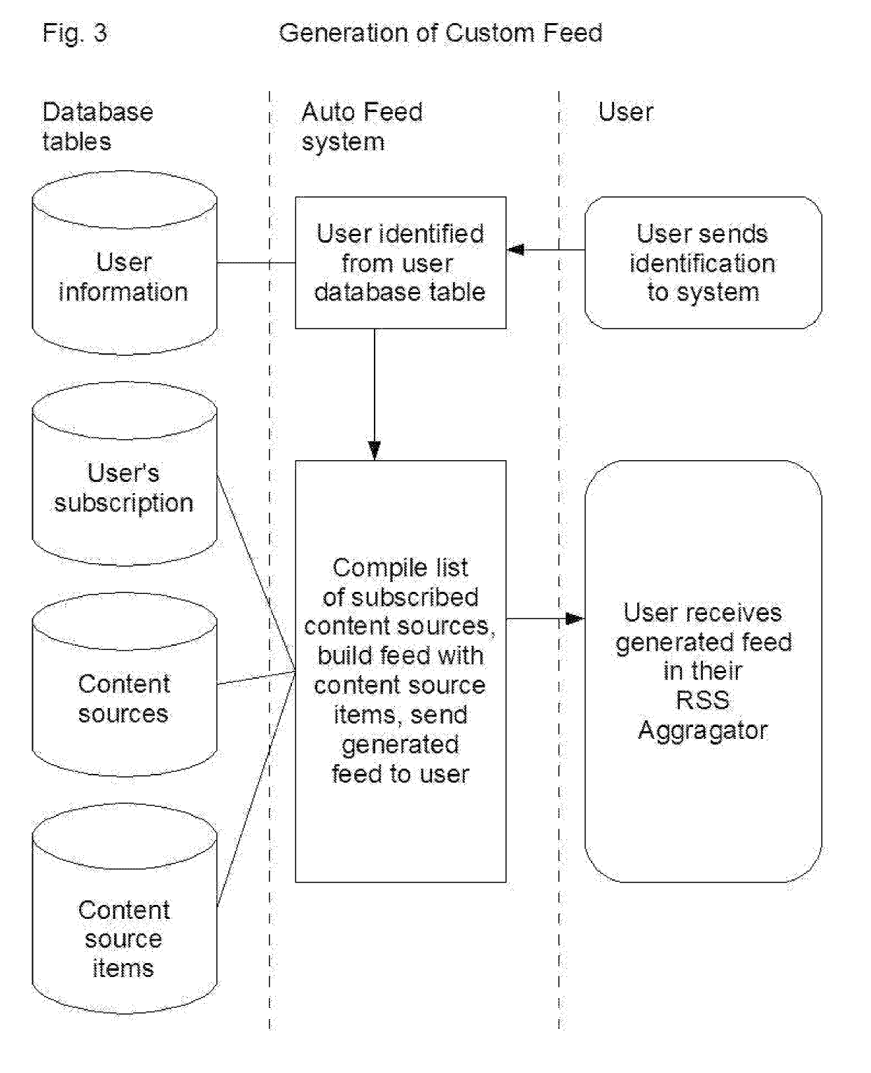

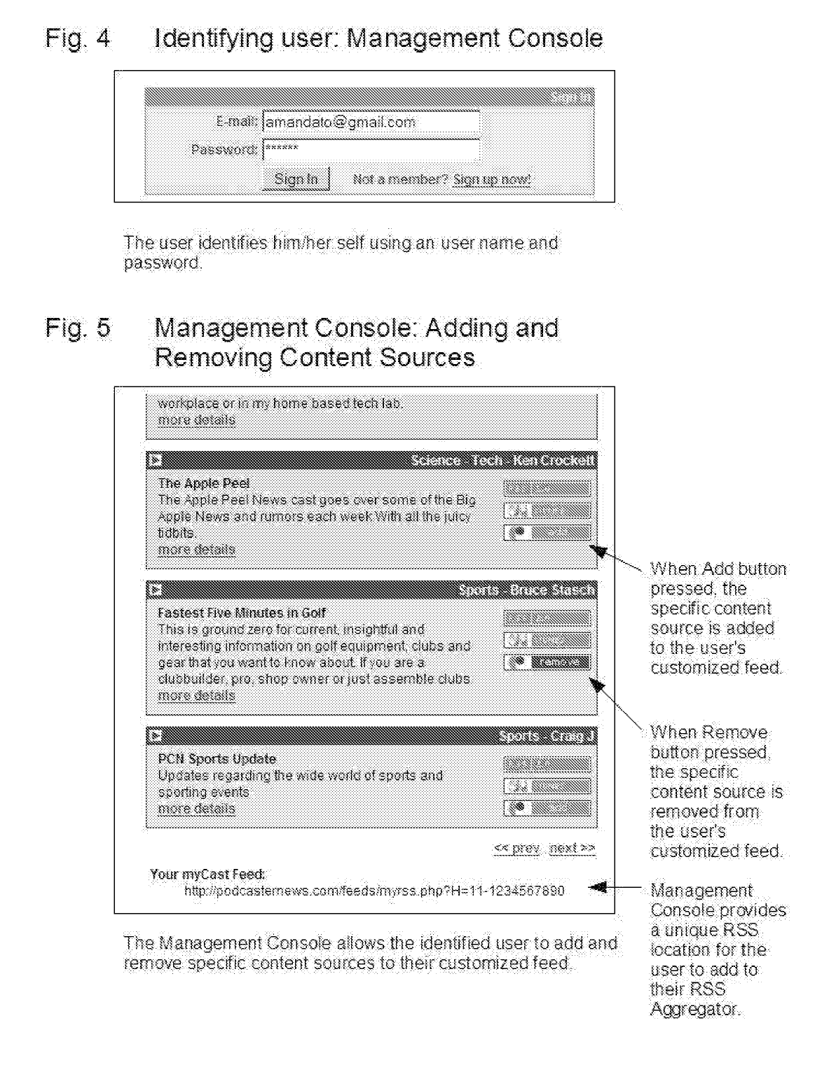

A preferred embodiment of the closure of the present invention is illustrated in FIG. 1, FIG. 2 and FIG. 3. FIGS. 4 through 8 demonstrate screenshots of an example of the preferred embodiment of the closure of the present invention.

The present invention provides a method for web servers to provide a customized feed to a user for managing audio and/or video data. Users can manage their customized feed by using a management console. The management console provides an interface to allow users to add and remove content sources to their customized feed. Users typically use Aggregators such as iTunes to access their unique feed location. The generation of the feed occurs when the unique feed location is accessed by an Aggregator or by other software that may access the unique feed location over a network or the Internet. The generated feed is formatted with extensible markup language (XML) tags that Aggregators can interpret. The management console and the unique feed location use a method to identify the user.

FIG. 1 shows an overall method for providing and managing a customized feed for a user in accordance with an embodiment of the present invention. The user is an individual who uses a personal computer (PC) to access a specific web server that includes the present invention. A user's PC is required to send identification information to the web server in order for the web server to identify who the user is. Once the user is identified, the management console, auto generated RSS feed and auto generated web page (HTML) are accessible.

The preferred method for identifying a user for access to the management console is by a user name and password. FIG. 4 demonstrates a method via a web browser and a web server to identify a user with a unique user name and password. Other methods of identification include a unique domain name, a HTTP Cookie, an E-mail address, or a unique Uniform Resource Locator (URL).

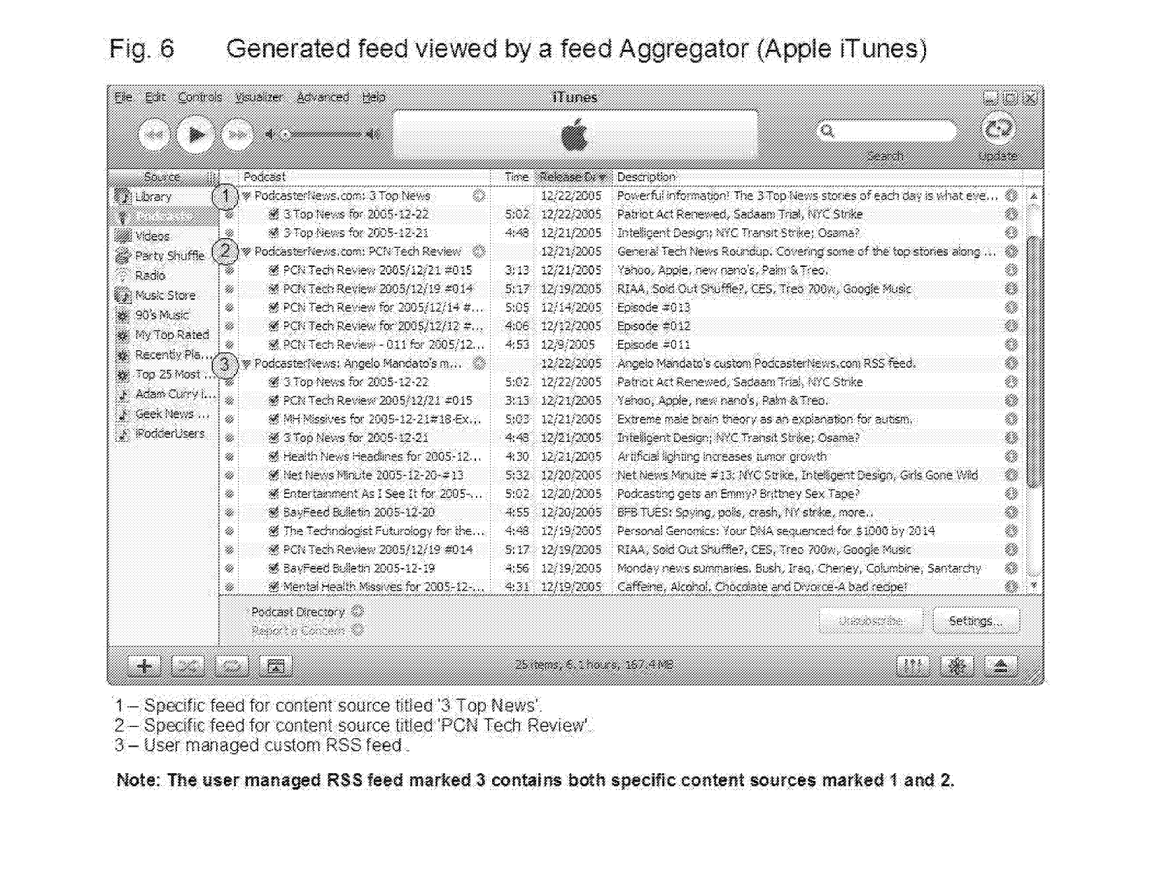

The preferred method for identifying a user for access to a generated custom RSS feed is by a unique feed location. FIG. 5 demonstrates a unique feed location in the format of a URL. Other methods of identification include a unique domain name, a HTTP cookie, an E-mail address, or with a unique user name and password.

The preferred method for providing a management console for the identified user to manage specific content sources is illustrated in FIG. 5. The management console displays specific details regarding specific content sources available to the user. The management console provides buttons to allow the user to add and remove content sources from their managed feed.

FIG. 2 demonstrates the method for maintaining a user's customized feed. When a user is identified, the management console will create a list of content sources to display to the user. The list consists of details regarding each content source and a button to allow the user to add or remove the content source to their custom feed. When a content source is added, the management console will add a database entry to a subscription table. The subscription table is a relational table that maintains a list of specific users to specific content sources. When a content source is removed, the management console will remove the database entry from the subscription table. Once an add or remove operation is completed, an updated list of content sources is returned to the user. Each content source will feature an ‘add’ button if it is not found in the subscription table for the user. Each content source will feature a ‘remove’ button if it is found in the subscription table for the user.

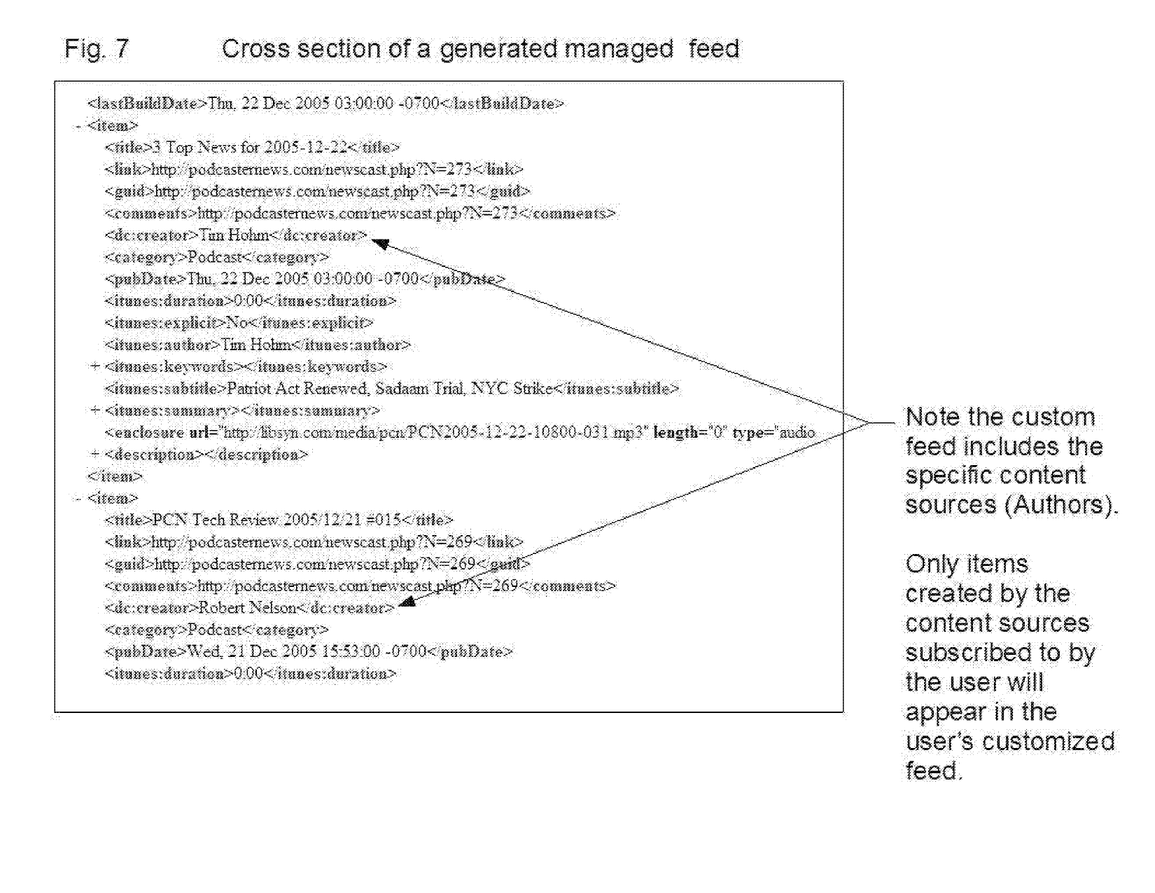

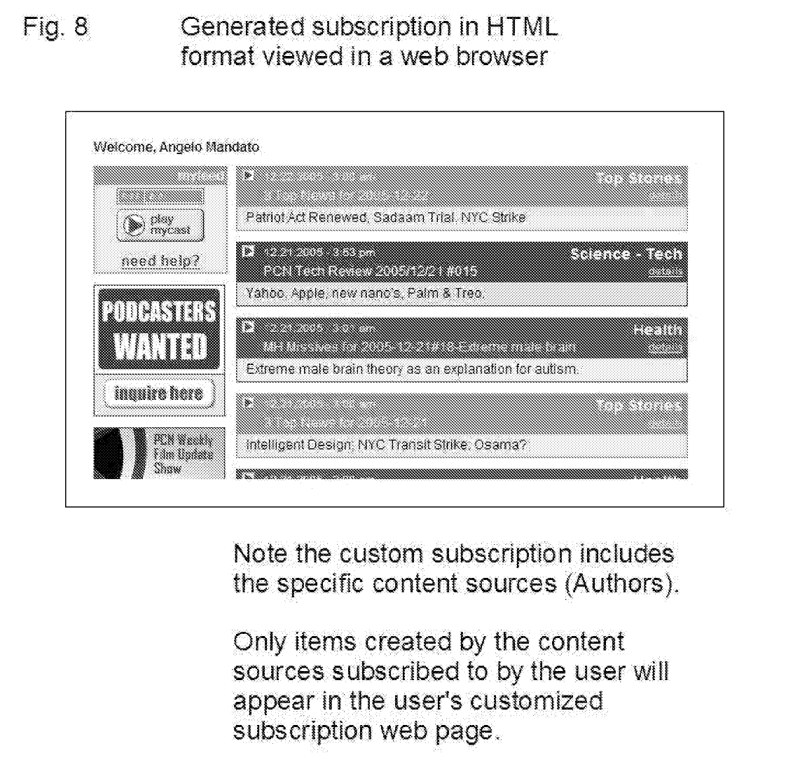

FIG. 3 demonstrates the method for generating the custom feed for an identified user. When a unique feed location is accessed by a user, the web server where the unique feed location resides will update and return an updated feed containing content items (audio and/or video URL links with descriptions) created by the subscribed content sources. The web server will create this list by querying the subscription table to get the list of content sources for the identified user. A query will then build a list of content items from the content source items database table to generate the user's customized feed. The resulting feed is formatted in Really Simple Syndication (RSS) format for the user's Aggregator to interpret. The resulting feed may also be formatted in ATOM (an XML-based Web content and metadata syndication format) and Outline Processor Markup Language (OPML). See FIG. 7 to see a cross section of a RSS feed that contains multiple content sources. See FIG. 6 for an example of the customized feed viewed within a feed Aggregator (Apple iTunes).

In an alternative embodiment of the invention, the user can access the managed subscription of content sources in the form of a web page to be viewed in a web browser. See FIG. 8 for an example of the customized subscription viewed within a web browser. Once the web server identifies the user, a formatted web page in Hypertext Markup Language (HTML) can be generated. First, the user needs to be identified. The preferred method is by a user name and password. Other identification methods include a unique domain name, a HTTP cookie, an E-mail address, or a unique Uniform Resource Locator (URL). Once the user is identified, the web server will create a list of content sources by querying the subscription table. A query will then build a list of content items from the content source items database table to generate the user's customized web page.

The reader will see that the manageable feed for distributing audio and/or video content for a specific user can be used to allow a user to manage and access a customized feed containing specific content sources. Those of skill in the art should find this method to provide a manageable feed for a user to be simple to construct and implement. In addition, users of the present invention should find the method to manage and use the customized feed to be fast and simple. The present invention allows a user to subscribe to specific content sources with the knowledge that content sources with common attributes that are not subscribed to are not included.

What is claimed is:

1. A method for producing a manageable feed for distributing audio and/or video content for a specific user, the method comprising: identifying the user; providing a management console for the identified user to manage specific content sources; providing a unique feed location for the specific user; generating the managed feed when the unique feed location is accessed.

2. The method of claim 1, wherein the identification of the user comprises of at least one of: a unique domain name, HTTP cookie, unique Uniform Resource Locator (URL), a user name and password, a unique identifier, an E-mail address.

3. The method of claim 1, wherein the provided management console for the specified user provides a means for adding specific content sources.

4. The method of claim 3, wherein the means for adding specific content sources is provided via one of: a web page, a software application.

5. The method of claim 4, wherein the web page includes a means for the user to add the specified content source via one of a button, an image, a web link, a Javascript function, a text box, a list box.

6. The method of claim 4, wherein the software application includes a means for the user to add specified content sources via one of a button, link, drag and drop, right mouse click, an image, a list box, a text box, a text string.

7. The method of claim 1, wherein the provided management console for the specified user provides a means for removing specific content sources.

8. The method of claim 7, wherein the means for adding specific content sources is provided via one of a web page, a software application.

9. The method of claim 8, wherein the web page includes a means for the user to remove the specified content source via one of a button, an image, a web link, a javascript function, a text box, a list box.

10. The method of claim 7, wherein the software application includes a means for the user to remove specified content sources via one of a button, link, drag and drop, right mouse click, an image, a list box, a text box, a text string.

11. The method of claim 1, wherein the provided unique feed location for the specified user comprises of at least one of a unique domain name, unique Uniform Resource Locator (URL), a user name and password, a unique identifier, an E-mail address.

12. The method of claim 1, wherein generation of the managed feed is performed when the unique feed location is accessed comprises: the managed content sources specified by the unique feed location.

13. The method of claim 12, wherein the unique feed location comprises of at least one of a unique domain name, HTTP cookie, unique Uniform Resource Locator (URL), a user name and password, a unique identifier, an E-mail address.

14. The method of claim 13, wherein the unique feed location may require zero or more of: a user name, a password, an E-mail address, an unique identifier, a HTTP cookie, an IP address.

15. The method of claim 1, wherein the unique feed location can be in the form of: a web page in Hypertext Markup Language (HTML); derivatives of HTML.

16. The method of claim 1 wherein the unique feed location can be formatted in at least one of: Really Simple Syndication (RSS) format; ATOM (an XML-based Web content and metadata syndication format); Outline Processor Markup Language (OPML); other variations of Extensible Markup Language.

17. The method of claim 1, wherein a content source may consist of: audio data; video data; textual information describing the audio data; textual information describing the video data.

18. The method of claim 17, wherein video and audio data can be located on one or more of: a web server, personal computer connected to a network.
